(19) United States
(12) Patent Application Publication
(10) Pub. No.: US 2002/0066383 A1
(43) Pub. Date: Jun. 6, 2002

(54) Process and apparatus for the treating of repeated imageable printing forms or printing form cylinders in printing machines

(76) Inventor: Arndt Jentzsch, Coswig (DE)

Correspondence Address: ROBERT M. MCDERMOTT, ESQ., 52 JAMES COURT, MONTROSS, VA, 22520, US

(21) Appl. No.: 09/924,159

(22) Filed: Aug. 7, 2001

(30) Foreign Application Priority Data
Aug. 9, 2000 (DE) 100 39 822.7

(51) Int. Cl. B41C 1/00; B41N 3/00

(52) U.S. Cl. 101/463.1; 101/401.1

(57) ABSTRACT

The invention relates to a method for repeated imageable printing forms or printing form cylinders, whereby the surfaces to be imaged are coated with an imageable layer.

Task of the invention is to establish a process and an apparatus for a fast and secure removal of the image carrying layer from the surface of an impression cylinder respectively from a printing plate.

The task is solved according the invention by applying layer with an imageable surface. This layer is treated with energy by an imaging device with a laser. The imaging device is also used to remove this layer whereby the intensity of the treatment is increased by the imaging device.

### FIELD OF INVENTION

The invention relates to a method for repeated imageable printing forms or printing form cylinders in printing presses, whereby the surfaces to be imaged are coated with an imageable layer.

The invention relates furthermore to an apparatus to apply this method, consisting of an imaging device with a laser allocated to a laser head.

### BACKGROUND OF INVENTION

A process for imaging respectively imaging and neutralization of a printing plate of a printing form cylinder of a printing press is known from DE 195 08 843 A1. The image information for imaging the printing plate is digitally. A medium carrying the image information is applied to the printing plate in a printing press and removed after the printing process from the printing plate in the printing machine.

A process for regeneration of an offset printing form is known from DE 41 23 959 C1. The regeneration of the printing form consists of removal of the imaging from the printing form and hydrophilization of the surface of the printing form. The regeneration is made according to this patent by applying an ionized process gas with an application device to the printing form. This causes a reactive erasing of the imaging and hydrophilization of the printing form simultaneously in the one process step. The created evaporating reaction products are sucked away by a suction device.

The high technical expenditures of this regeneration device for regeneration of printing plates are disadvantageous.

A printing process in which a water receptive layer is applied to the surface of a printing plate a printing form cylinder is known from U.S. Pat. No. 4,718,340. This water receptive layer is coated with an ink receptive coating. The printing image is created by partial removal of the ink receptive layer with an ablation laser so that printing and non-printing areas are established.

The ink receptive layer carrying the image information or both layers are removed during the regeneration of the printing form. The regeneration is made with the same ablation laser, which was used to establish the image information on the printing form.

The very time consuming process for removing the printing image respectively the layers is disadvantageous.

### SUMMARY DESCRIPTION OF INVENTION

Task of the invention is to realize a process and an apparatus for a fast and secure removal of the image carrying layer from the surface of the impression cylinders respectively the printing plate.

The task is solved according the invention by applying layer with an imageable surface. This layer is treated with energy by an imaging device with a laser. The imaging device is also used to remove this layer whereby the intensity of the treatment is increased by the imaging device.

The advantage with this invention is the considerable time reduction for removing the image information.

### BRIEF DESCRIPTION OF THE DRAWING

The invention is described below in greater detail by an embodiment of the invention, by reference being had to the drawing, wherein:

FIG. 1: Schematic of a printing unit with a laser head for transferring and removing image information

FIG. 2: Schematic of a printing unit with a laser head for transferring and removing image information and an additional laser connected through a optical fiber transmission

FIG. 3: Schematic of a printing unit with a laser head for transferring and removing image information and an additional laser coupled by a mirror system

### DETAILED DESCRIPTION

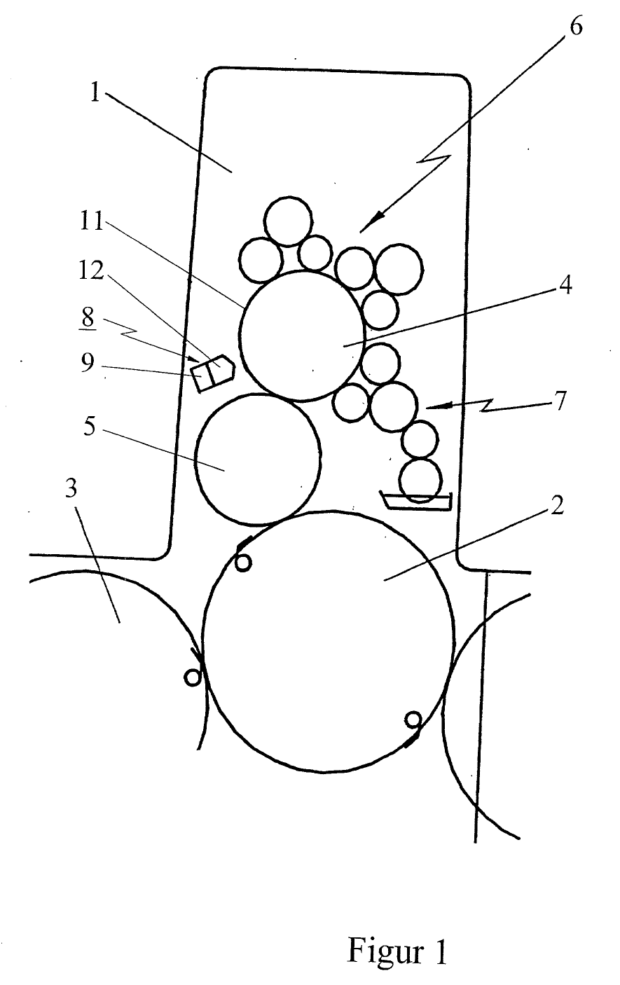

FIG. 1 shows a printing unit of a multi color sheet fed offset press. The printing unit 1 contains a sheet transporting impression cylinder 2, a transfer drum 3, a printing form cylinder 4 carrying the printing image and a blanket cylinder 5.

Each printing form cylinder 4 is connected with an inking unit 6 and a dampening unit 7. The printing form cylinder 4 can carry a—here not shown—printing form.

An imaging device 8 mounted in the not shown frame of the printing press is allocated to the printing form cylinder 4. The imaging device 8 consists of a laser head 12 with the integrated laser 9. The power of the laser 9 can be controlled. Solid state or gas discharge lasers can be used.

The invented process is realized with this apparatus in the following way:

A medium is applied to the surface of the printing form cylinder 4 or in case that a printing plate is used to the surface of printing plate by a not shown coating device during which the impression, the inking unit 6 and the dampening unit 7 are disengaged. A layer 11 is established. This layer consists in the embodiment of a polymer.

The imaging device 8 is now imaging the applied medium on the printing form cylinder 4. The imaging data is processed by a not shown computer in the known way and transmitted to the imaging device 8. The rotational speed of the printing form cylinder 4 is synchronized with the movement of the imaging device 8. In the result of the imaging process the surface of the layer 11 receives the image information and the polymer in the printing areas is hardened by the laser beam establishing printing and non-printing areas. An appropriate device must remove the non-polymerized material from the non-printing areas. The printing can now start.

The imaging of the printing form cylinder 4 is removed after printing. The imaging device 8 now working as an ablation laser removes the layer 11 from the surface of the printing form cylinder or the printing plate. The intensity of the laser beam of the imaging device 8 increased for the removal process improving the impact on the treated surface. The performance increase of the laser 9 is made according to this invention by a change in the electrical operating parameters.

An advantageous embodiment of this invention uses a changed diameter of the laser beam by a changed focus to increase the reliability of the image removal.

The imaging of the applied layer 11 and the image removal are made during rotation of the printing form cylinder 4. It is therefore advantageous to disengage the printing form cylinder 4 from the drive system during imaging and image removal. For this purpose the printing form cylinder 4 has an own drive for imaging and image removal.

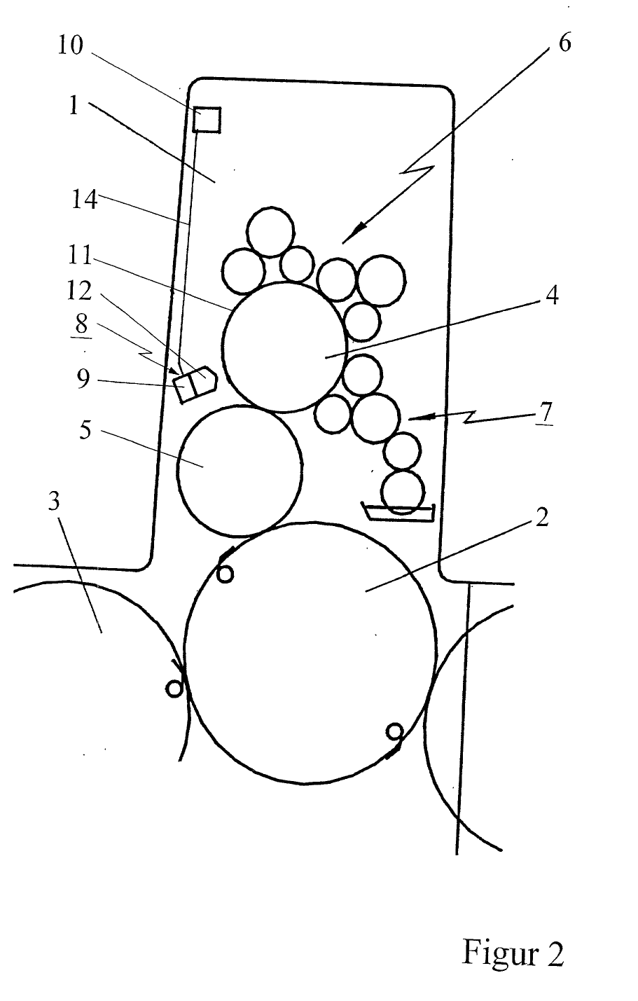

FIG. 2 shows another embodiment of the invention. The structure of the printing unit 1 is analogue to the above shown embodiment. The imaging device 8 consists also of a laser head 12 with a laser 9. The laser 9 is connected to a second laser 10 through a fiber optical cable 14. In another not shown embodiment multiple lasers are connected by fiber optical cable 14.

The invented process is realized with this apparatus in the following way:

Coating and imaging are analogue to the above described embodiment. The laser head 12 receives light from a second laser 10 respectively further lasers for image removal. Thus increasing the laser intensity effecting the treated surface.

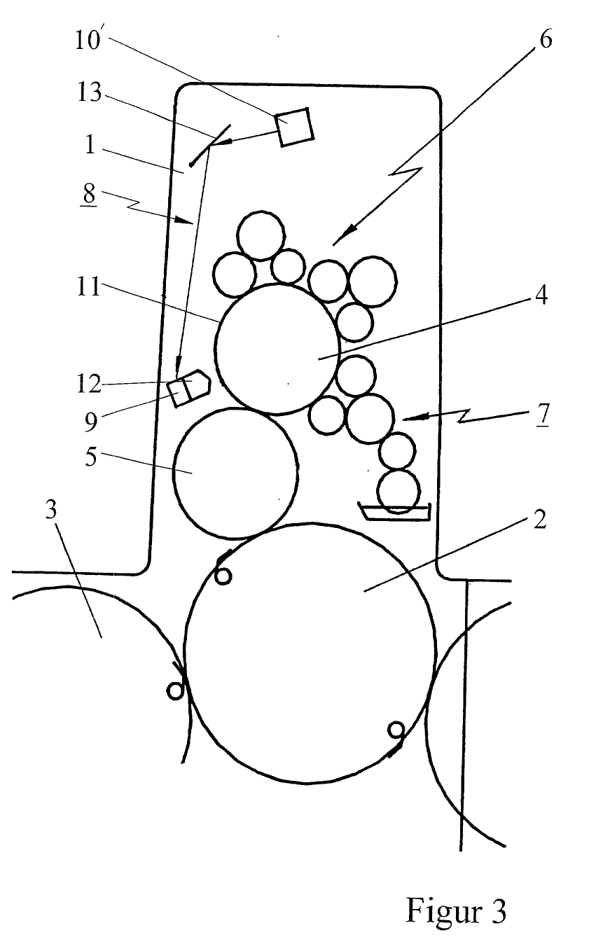

FIG. 3 shows a further embodiment of the invention. The structure of the printing unit 1 is analogue to the embodiment shown above. The imaging device 8 consists also of a laser head 12 with a laser 9. One or more laser 10′ are mounted in the vicinity of the laser 9 and supplying their energy through a mirror system 13 to the laser 9 if needed.

The invented process is realized with this apparatus in the following way:

Coating and imaging are analogue to the above described embodiment. The laser head 12 receives light from a second laser 10′ through a mirror system 13 for image removal. Thus increasing the laser intensity effecting the treated surface and removing the layer within shortest time.

We claim:

1. Process for treating repeated imageable printing forms or printing form cylinders in printing presses
whereby
an imageable coating is applied to surface to be treated
the coating is treated with energy by an imaging device with a laser for creating the image information
the imaging device is also used for removal of the coating,
the imaging device increases the intensity to the treated surface during removal of the coating.

2. Process for treating repeated imageable printing forms or printing form cylinders in printing presses according to claim 1
whereby the image carrying elements are polymerized by applying energy to the coating during imaging.

3. Process for treating repeated imageable printing forms or printing form cylinders in printing presses according to claim 1
whereby the laser power is increased appropriately for power amplification of the imaging device during coating removal.

4. Process for treating repeated imageable printing forms or printing form cylinders in printing presses according to claim 1
whereby at least one additional laser is switched for power amplification of the imaging device during coating removal.

5. Process for treating repeated imageable printing forms or printing form cylinders in printing presses according to claim 1 to 4
whereby the diameter of the laser beam is increased during image removal.

6. Apparatus for treating repeated imageable printing forms or printing form cylinders in printing presses consisting of an imaging device with a laser or a laser head
whereby laser with controllable power is used.

7. Apparatus for treating repeated imageable printing forms or printing form cylinders in printing presses consisting of an imaging device with a laser or a laser head
whereby a second laser is allocated to the laser head.

8. Apparatus for treating repeated imageable printing forms or printing form cylinders in printing presses consisting of an imaging device with a laser or a laser head
whereby a second laser is allocated to the laser head through a fiber optic cable.

9. Apparatus for treating repeated imageable printing forms or printing form cylinders in printing presses consisting of an imaging device with a laser or a laser head
whereby second laser is allocated to the laser head by a mirror system.

10. Apparatus for treating repeated imageable printing forms or printing form cylinders in printing presses according to claim 7 to 9
whereby multiple lasers are allocated to the laser head.

11. Apparatus for treating repeated imageable printing forms or printing form cylinders in printing presses according to the preceding claims
whereby the emitted wavelength of the first and the additional lasers are approximately the same.

12. Apparatus for treating repeated imageable printing forms or printing form cylinders in printing presses according to the preceding claims
whereby the lasers are either solid state lasers or gas discharge lasers.
